(19) United States
(12) Patent Application Publication
(10) Pub. No.: US 2024/0003794 A1
(43) Pub. Date: Jan. 4, 2024

(54) Method and Device for Determining or Testing the Mechanical Integrity of Medicament Containers

(71) Applicant: Sanofi, Paris (FR)

(72) Inventors: Christophe Agut, Paris (FR); Paolo Mangiagalli, Paris (FR); Stefano Martini, Paris (FR); Cinzia Rotella, Paris (FR)

(21) Appl. No.: 18/253,148

(22) PCT Filed: Nov. 15, 2021
(86) PCT No.: PCT/EP2021/081648

§ 371 Date: May 16, 2023

(30) Foreign Application Priority Data
Nov. 17, 2020 (EP) 20315454.7

(51) Int. Cl. G01N 3/30

(52) U.S. Cl. CPC G01N 3/30

(57) ABSTRACT

The present disclosure relates to a method of determining or estimating a burst pressure resistance of a batch of medicament containers, wherein each medicament container of the batch of medicament containers includes a vitreous barrel filled with a liquid substance and is sealed by a stopper slidably disposed inside of the vitreous barrel. The method includes applying a mechanical impact of a predefined magnitude onto the stopper of each medicament container of a subset of the batch of medicament containers, determining a breakage rate of vitreous barrel of the subset of the batch of medicament containers that are mechanically damaged by the mechanical impact, and deriving the burst pressure resistance of the batch of medicament containers based on the breakage rate of the vitreous barrels mechanically damaged by the mechanical impact.

### CROSS REFERENCE TO RELATED APPLICATIONS

The present application is the national stage entry of International Patent Application No. PCT/EP2021/081648, filed on Nov. 15, 2021, and claims priority to EP Application No. 20315454.7, filed on Nov. 17, 2020, the disclosures of which are incorporated herein by reference.

### TECHNICAL FIELD

The present disclosure relates to the field of medicament containers and in particular to medicament containers comprising a vitreous barrel filled or fillable with a liquid medicament. In some aspects the disclosure relates to medicament containers, such as prefilled syringes intended for use with disposable or reusable injection devices, such as pen-type injectors or so-called autoinjectors. In some aspects the disclosure relates to a method of determining or estimating the mechanical integrity of a medicament container selected from a batch of medicament containers. In some aspects the disclosure relates to a method of determining or estimating a burst pressure resistance of a batch of medicament containers. In still another aspect the disclosure relates to a method of correlating a burst pressure resistance of a medicament container with a breakage rate of respective barrels, in particular when subject to a well-defined mechanical impact.

### BACKGROUND

Medicament containers, such as cartridges, ampoules or prefilled syringes either for manual use or for use in medical devices are generally known in the art. Such medicament containers typically comprise a barrel made of a vitreous material that is substantially inert with regard to the medicament to be stored or accommodated in the interior volume of the barrel.

Vitreous materials, such as glass, typically exhibit a substantial sensitivity or vulnerability with regard to mechanical impact. Such vitreous materials are shock sensitive and may be subject to cracking, shattering or other mechanical damage that may harm the integrity of the barrel when exposed to mechanical load or impact.

Further, there exist medicament containers with an elongated barrel having a distal end provided with an outlet for the liquid medicament and further comprising a proximal end. Here, the proximal end may be sealed by a stopper or piston slidably displaced inside the barrel. On the one hand, the stopper or piston, typically made of an elastomeric material, seals the proximal end of the barrel. On the other hand, the stopper or piston is movable in distal direction in order to expel an amount, e.g. a well-defined dose of the medicament from the interior of the barrel through the distal outlet.

For moving the stopper or piston towards the distal direction a certain pressure must be applied, e.g. by way of a plunger or piston rod connected or connectable to the stopper or piston. A movement of the piston or stopper towards the distally located outlet inevitably leads to an increase of the pressure inside the barrel of the medicament container. Accordingly, the barrel must be designed and configured to withstand such an increased pressure.

With some application scenarios the medicament container itself might be subject to a movement inside an injection device. This particularly applies to autoinjectors typically equipped with a prefilled syringe or being equipped with a cartridge and an injection needle. Here, the medicament container and/or the injection needle are subject to a movement relative to a housing of the injection device for bringing the syringe in an exposed position, in which it protrudes from the distal end of the housing. Additionally or alternatively, such injection devices may be equipped with a biased firing mechanism or drive mechanism by way of which mechanical energy stored in or by the drive mechanism can be released in order to urge the piston or stopper of the medicament container in distal direction.

Release of stored mechanical energy may come along with a rather fast and abrupt distally directed advancing motion of a plunger or piston rod rather abruptly applying a distally directed force effect or impact onto the barrel and/or onto the stopper or piston of the medicament container.

For reasons of patient safety an uncontrolled breakage or damage of medicament containers during use of such autoinjectors should be avoided. But when implemented for instance in an autoinjector the medicament container is inevitably subject to a mechanical impact that may harm the integrity of the medicament container or of its barrel.

From the point of view of a manufacturer of vitreous barrels it is quite difficult to manufacture barrels featuring specifications that precisely match with the particular demands for the subsequent use of barrels or medicament containers.

Typically, the quality or mechanical stability of a barrel can be characterized or determined by its burst pressure resistance. Here, the barrel is to filled with a liquid substance. The proximal end of the barrel is sealed by a plug opportunely fitting the proximal internal diameter of the barrel and the outlet at the distal end is either clogged or sealed so that the liquid substance remains inside the barrel. Then, a gradually increasing hydraulic pressure is applied through the inner plug while the barrel is fixed or supported with regards to the distal direction. While the pressure applied through or by the inner plug is gradually increased the pressure or force effect is continuously measured until the burst pressure resistance of the medicament container has been reached. Consequently, and when exceeding the burst pressure resistance, the vitreous body of the barrel is subject to disintegration and breaks. Instead of increasing the hydraulic pressure through the plug, it is generally also conceivable to apply a distally directed pressure to the plug or piston sealing the proximal end of the barrel, thereby also increasing a fluid pressure inside the barrel.

Even though the quality of a batch of barrels or medicament containers can be in principle quantitatively determined by such burst pressure resistance measurements, such a measurement is somewhat useless for the intended scenario of use in in an autoinjector, where the medicament container or the barrel is subject to a certain mechanical impact. From the rather steady-state or quasi-continuous measurement in the course of a burst pressure resistance test, precise conclusions cannot be drawn how the respective barrel or medicament container will behave or react when it is subject to mechanical impact.

Mass manufactured medicament containers, at least to a certain degree, typically comprise some surface imperfections, such as micro cracks or flaws. It is yet impossible to deterministically determine the effect or implication of such imperfections on a breakage rate of medicament containers when used in an autoinjector. Moreover, characterizing a batch of medicament containers with regards to a burst pressure resistance does not allow for a reliable estimation how such medicament containers behave in an autoinjector, where they are subject to mechanical impact. Up to now, the mere characterization of a medicament container in terms of a burst pressure resistance does not allow to estimate or to predict a breakage rate when using such medicament containers in an autoinjector.

It is therefore an aim of the present disclosure to provide an alternative way or method of determining or estimating a burst pressure resistance of a medicament container that is closely correlated to the intended use of the medicament container in an injection device, in particular in an autoinjector. It is a further aim to allow and to provide a mutual mapping of a burst pressure resistance of a batch of medicament containers with a breakage probability or breakage rate of such medicament containers when used in an injection device, such as an autoinjector.

Moreover, it is a further aim to provide a device for determining or estimating at least one of a burst pressure resistance and a breakage rate of a batch of medicament containers.

### SUMMARY

In one aspect the disclosure relates to a method of determining or estimating a burst pressure resistance of a batch of medicament containers. The medicament containers each comprise a vitreous barrel filled with a liquid substance and sealed by a stopper. The stopper is slidably disposed inside the vitreous barrel. Typically, the barrel is made of glass. It may comprise a glass body. The vitreous material the barrel is made of comprises glass or is glass. The method comprises a step of applying a mechanical impact of a predefined magnitude onto the stopper of a subset of medicament containers of the batch of medicament containers. After applying the mechanical impact, a breakage rate of barrels of the subset of medicament containers being mechanically damaged by the application of the mechanical impact is determined. Thereafter and in a further step the burst pressure resistance of the batch of medicament containers is derived or estimated on the basis of the breakage rate of barrels that have been mechanically damaged by the application of the mechanical impact.

Accordingly, the method provides a quantitative as well as qualitative approach to determine a burst pressure resistance of a batch of medicament containers only by conducting a mechanical impact test of the batch of medicament containers. Typically, the subset of the medicament containers of the batch of medicament containers is treated in the same way. Each one of the medicament containers of the subset of the batch of medicament containers is subject to the same mechanical impact of predefined magnitude. In effect, a subset of medicament containers is taken from a batch of medicament containers and is subject to a mechanical impact.

Depending on the magnitude of the mechanical impact and depending on the quality or mechanical resistance of the batch of medicament containers a certain portion of the subset of medicament containers that has been subject to the mechanical impact testing will be damaged. A respective breakage rate or breakage ratio of those medicament containers or barrels broken during the impact testing is a direct indicator of the burst pressure resistance of the batch of medicament containers from which the subset of medicament containers has been taken.

In this way, a manufacturer of medical devices or injection devices to be used with such medicament containers may conduct a series of burst testing and/or of impact testing of subsets of medicament containers taken from different batches of medicament containers and may then define a minimum burst pressure resistance for medicament containers to be manufactured and supplied by a manufacturer of vitreous barrels.

In effect, it can be provided and ensured, that a batch of medicament containers featuring a burst pressure resistance above a required minimum burst pressure resistance will exhibit a breakage rate when used in a medical device or injection device that is below a tolerable maximum breakage rate as defined by the manufacturer of the medical device or injection device.

According to a further example deriving of the burst pressure resistance of the batch of medicament containers includes providing and/or using of a correlation between the burst pressure resistance of the medicament containers and the breakage rate of the barrels mechanically damaged by the application of the mechanical impact in an impact testing arrangement. The correlation between the burst pressure resistance of the medicament containers and the breakage rate of the barrels can be determined by experiments and by a respective processing of experimental data. In this way an at least empiric correlation between the burst pressure resistance of the medicament containers and the breakage rate of the barrels when subject to a mechanical impact testing can be provided.

Based on an empirically obtained correlation it is then possible to derive or estimate a burst pressure resistance of a batch of medicament containers without conducting a typical burst pressure resistance test, where a gradually increasing pressure has to be applied to or via a stopper of the medicament container. Moreover, and the other way round it is also possible to derive or to estimate a breakage rate or an impact resistance of a batch of medicament containers by only conducting a series of burst pressure tests, where a gradually increasing inside pressure is applied to the barrel. Based on a series of burst pressure tests for determining a burst pressure resistance of a batch of medicament containers, a breakage rate of respective medicament containers when subject to an instantaneous impact can be derived.

Typically, the correlation between the burst pressure resistance of the medicament containers and the breakage rate of the barrels is obtained by a series of experiments under well-defined conditions. The experimental data can be appropriately processed in order to provide a respective correlation.

According to a further example, providing of the correlation between the burst pressure resistance of the medicament containers and the breakage rate of the barrels of such medicament containers includes artificially generating a first mechanical defect of a first magnitude in or on a first group of barrels and artificially generating a second mechanical defect of a second magnitude in or on a second group of barrels. Typically, the first and the second magnitude are different. By artificially generating at least two different mechanical defects in different groups of barrels it is possible to mutually correlate the burst pressure resistance of the batch of medicament containers with the breakage rate of respective barrels of the batch of medicament containers.

With some further examples not only a first and a second group but numerous groups, e.g. 3, 4, 5, 6 or up to 10, 20 or even 50 different groups of barrels may be determined, each being subject to an artificially generated respective mechanical defect. Hence, each group of barrels may distinguish from another group by the degree or magnitude of its artificially created mechanical defect. The groups of barrels distinguish by their magnitude of the artificially generated mechanical defect.

Implementing or artificially generating different degrees or magnitudes of mechanical defects with respective groups of barrels allows to derive a quantitative correlation between the size or magnitude of the artificially generated mechanical defect and at least one of a breakage rate when subject to a well-defined mechanical impact and a respective burst pressure resistance when subject to a burst pressure resistance test.

In general, and according to a further example the burst pressure resistance of a batch of medicament containers can be or is correlated to the breakage rate of its barrels when subject to a well-defined mechanical impact by the at least first and second mechanical defects artificially generated in the first and the at least second group of the barrels.

A group of barrels may contain a well-defined number of barrels taken from a common batch of barrels of medicament containers. Typically, a group of barrels may contain at least 10 barrels, at least 20 barrels, at least 50 barrels or at least hundred barrels or even more. The larger the number of barrels in a group of barrels is, the better may be the statistical analysis of the burst pressure resistance and/or of the breakage rate determined by respective experiments. In addition, also an increasing number of groups of barrels that distinguish by the magnitude of the respective mechanical defect may help to improve the precision of the mutual correlation of the burst pressure resistance and the breakage rate of the barrels.

Moreover, the two different ways to characterize the mechanical integrity of a batch of medicament containers, namely by measuring of the burst pressure resistance or by measuring of a breakage rate when subject to a mechanical impact can be mutually correlated by the artificially generated mechanical defects. Typically, for providing of the correlation between the burst pressure resistance of the medicament containers and the breakage rate of the barrels from the same batch, a statistical analysis of numerous barrels belonging to different groups of barrels will be conducted. In this way, natural variations of the mechanical integrity of barrels that arise from the manufacturing process can be effectively compensated.

According to a further example providing of the correlation between the burst pressure resistance of the medicament containers and the breakage rate of the barrels further includes measuring of a burst pressure resistance of a subset of the first group of barrels and measuring of a burst pressure resistance of a subset of the second group of barrels. Presumed that the first group of barrels comprises a mechanical defect with a first magnitude being larger than the second magnitude of a second mechanical defect of the second group of barrels, the burst pressure resistance of the subset of the first group of barrels will be lower than the burst pressure resistance of the subset of the second group of barrels.

Likewise, since the first mechanical defect of the first group of barrels is larger than the second mechanical defect of the second group of barrels, the breakage rate of the subset of the first group of barrels will be larger than the breakage rate of the subset of the second group of barrels when the subsets of the first and second groups of barrels should be subject to substantially equivalent or identical mechanical impact.

Measuring of the burst pressure resistance of the subset of the first group of barrels, of the subset of the second group of barrels and of a subset of further group of barrels being provided with respective artificially generated mechanical defects, allows to provide and to derive a quantitative correlation between the magnitude of a mechanical defect and the burst pressure resistance. In effect, artificially generating different mechanical defects in different groups of barrels enable to derive a quantitative correlation between the burst pressure resistance and the degree or magnitude of a mechanical defect.

Reversibly, measuring of a burst pressure resistance of a subset of barrels may allow to estimate and/or to determine the magnitude of the artificially generated or of a fictive mechanical defect. Hence, by measuring of a burst pressure resistance of a subset of barrels it may be determined or at least estimated from which group of barrels the specific barrel has been taken from.

According to a further example providing of the correlation between the burst pressure resistance of the medicament containers and the breakage rate of the barrels further includes deriving of a first correlation between the burst pressure resistance and the magnitude of the artificially generated mechanical defect of the barrels. The burst correlation can be obtained by conducting a number of burst pressure experiments with a subset of the first group of barrels and with a subset of the second group of barrels and optionally with further subsets of a third, fourth or fifth group of barrels, and so on. Typically, for each group of barrels, a particular number, hence a subset of barrels is subject to the burst pressure resistance test. Here, for each barrel or medicament container of a subset of a group of barrels the burst pressure resistance can be determined individually. Conducting such a burst pressure resistance test for a comparatively large number of barrels allows and provides to conduct a statistical data analysis to derive a first correlation between the burst pressure resistance and the magnitude of the artificially generated mechanical defect.

Typically, and with further examples, deriving of the burst correlation between the burst pressure resistance and the magnitude of the artificially generated mechanical defect includes applying a numerical regression analysis. The numerical regression analysis is applied to the statistical data obtained for a number of burst pressure resistance tests conducted for a subset of at least the first group of barrels and a subset of at least the second group of barrels.

According to a further example, providing of the correlation between the burst pressure resistance of the medicament containers and the breakage rate of the barrels includes applying a mechanical impact of predefined magnitude onto the stopper of a further subset of the first group of barrels and determining a breakage rate of the barrels of the further subset of the first group of barrels that have been mechanically damaged by the application of the mechanical impactful. A corresponding impact testing is also applied to a further subset of the second group of barrels. Hence, the method includes applying the mechanical impact of predefined magnitude onto the stopper of a further subset of the second group of barrels and to determine a breakage rate of barrels of the further subset of the second group of barrels that have been mechanically damaged by the application of the mechanical impact.

Here, the subset of the first group of barrels and the further subset of the second group of barrels is subject to the same magnitude or type of mechanical impact in order to provide comparable results. Typically, when the magnitude of the first mechanical defect of the first group of barrels is larger than the magnitude of the second mechanical defect of the second group of barrels the breakage rate of the further subset of the first group of barrels will be larger than the breakage rate of the further subset of the second group of the barrels.

Artificially generating mechanical defects of different magnitude into different groups of barrels and conducting of well-defined mechanical impact testing for subgroups of these artificially damaged barrels allow to derive a correlation between the magnitude of the mechanical defect and the breakage rate of the respective barrels when such barrels are subject to a well-defined impact test, which may mimic a mechanical impact the medicament container is exposed to when assembled inside and used with an injection device, such as an autoinjector.

According to a further example providing of the correlation between the burst pressure resistance of the medicament containers and the breakage rate of the barrels further includes deriving of a breakage correlation between the breakage rate of the barrels and the magnitude of the artificially generated mechanical defect of the barrels. Also here, deriving of the breakage correlation between the breakage rate of the barrels and the magnitude of the artificially generated mechanical defect may include applying of a numerical regression analysis.

Moreover, deriving of the breakage correlation may be based on a comparatively large number of mechanical impact testing events of the subset of the at least first group of barrels and the subset of the at least second group of barrels and/or of a subset of further groups of barrels.

According to a further example there may be provided first and second groups of barrels that distinguish by the magnitude of their artificially generated mechanical defect. In effect, a subset or a subgroup of the first group of barrels will be subject to a burst pressure resistance test while another subset or another subgroup of the same group of barrels will be subject to mechanical impact testing. The same applies to all further groups of artificially damaged or structurally weakened barrels. In this way, experimental data obtained for the numerous groups of barrels with regards to the burst pressure resistance testing and with regard to the impact testing become mutually comparable and can be mutually correlated by the artificially generated defects.

To conclude—in this way the burst pressure resistance of a batch of medicament containers can be estimated or determined on the basis of conducting an impact testing of the barrels of the batch of medicament containers. Vice versa, a breakage rate, typically obtained via conducting an impact test of medicament containers or barrels thereof can be determined or estimated on the basis of a conventional burst pressure resistance test.

According to a further example, deriving of the breakage correlation between the breakage rate of barrels and the magnitude of the artificially generated mechanical defect includes applying a numerical regression analysis on the basis of the breakage rate determined for each of the first and second subgroups of the barrels mechanically damaged by the application of the mechanical impact.

Accordingly and with a further example, deriving of the burst correlation between the burst pressure resistance and the magnitude of the artificially generated mechanical defect includes applying a numerical regression analysis on the basis of the burst pressure resistance determined for each of the first and second subgroups of barrels when subject to a respective measurement of the burst pressure resistance.

With a further example, deriving of at least one of the breakage correlation and the burst correlation with regard to the artificially generated mechanical defect includes deriving or determining of a numerical regression model. This allows to determine at least one of the burst pressure resistance and a breakage rate versus a magnitude of the artificially generated mechanical defect for which no experimental data is available. Hence, the numerical regression analysis and/or deriving of a numerical regression model allows to interpolate and/or to predict at least one of a burst correlation and a breakage correlation even for such values of a burst pressure resistance, breakage rates and/or artificially generated mechanical defects, for which no experimental data is available. This allows to expand the coverage of the burst correlation and the breakage correlation.

According to another example the correlation between the burst pressure resistance of the medicament containers and the breakage rate of the barrels is derived by mutually correlating or combining the burst correlation and the breakage correlation on the basis of the magnitude of the artificially generated mechanical defect. Once the first correlation and the breakage correlation have been determined for numerous groups of barrels the respective correlations may be directly mapped or assigned to each other. In this way, a breakage rate e.g. measured by way of impact testing of a number of barrels may be directly transformed into a burst pressure resistance. Vice versa, a burst pressure resistance measured for a number of medicament containers or barrels can be transformed into an expected breakage rate when such barrels or medicament containers should be subject to well-defined mechanical impact, e.g. as it will be the case in an autoinjector for instance.

In this way, for a given burst pressure resistance of a medicament container a breakage rate of the medicament container when used in an injection device can be predicted. Vice versa, from a measured breakage rate of a medicament container used in a medical device, such as an autoinjector, a burst pressure resistance can be predicted or determined.

A pharmaceutical manufacturer or a manufacturer of a medical device, such as an autoinjector may conduct a series of impact tests with numerous batches of medicament containers.

Typically, the impact testing may mimic the mechanical loads typically arising in such an injection device. Based on the mutual correlation between the breakage rate of the barrels and the burst pressure resistance of the medicament containers the pharmaceutical manufacturer or device manufacturer may set up a lower specification limit for the burst pressure resistance of medicament containers to be used in such a device.

According to a further example the first and the second mechanical defects in or on the first and second groups of barrels each comprise at least one scratch in the vitreous barrel. The at least one scratch of the first mechanical defect distinguishes from at least one scratch of the second mechanical defect by at least one of a scratch geometry, a scratch morphology, a scratch shape, a scratch length, a scratch width, a scratch depth, a number of individual scratches and/or a spatial distribution of numerous individual scratches.

In effect, there are multiple and different ways to produce artificial defects of different magnitude in the first and second groups of barrels. Typically, the scratches may distinguish by their length, by their number, by their size or by their depth. Typically, the barrels of each group of barrels are provided with a common and identical scratch or mechanical defect. Of course, and from a practical point of view there may arise only slight but almost neglectable differences between mechanical defects of different barrels. Such deviations might be due to limitations of the defect generating equipment or defect generating procedure.

According to a further example and for a given breakage rate, which is measured for a group of barrels, a magnitude of an artificially generated mechanical defect is determined or estimated on the basis of the breakage correlation. Alternatively or additionally, for a given magnitude of an artificially generated mechanical defect of a group of barrels, an estimated breakage rate of the group of barrels is determined on the basis of the breakage correlation. Here, the breakage correlation derived on the basis of experimental data is used to mutually assign a breakage correlation with a magnitude of an artificially generated mechanical defect, and vice versa.

According to a further example, for a burst pressure resistance of a medicament container, which is measured for the medicament container, a magnitude of an artificially generated mechanical defect is determined or estimated on the basis of the burst correlation. The burst correlation has been derived on the basis of experimental data as described above.

According to a further example and alternatively or additionally for a given magnitude of an artificially generated mechanical defect of a group of barrels, an estimated burst pressure resistance of medicament containers including this particular group of barrels is determined on the basis of the burst correlation. Hence, the burst correlation provides a direct assignment between a magnitude of an artificially generated mechanical defect of the barrels with the burst pressure resistance of medicament containers including these barrels; and vice versa.

According to another aspect, the present disclosure further relates to a method of correlating a burst pressure resistance of medicament containers with a breakage rate of the vitreous barrels of such medicament containers. Also here, the medicament containers comprise a vitreous barrel filled with a liquid substance and being sealed by a stopper, piston or plug. The method comprises the steps of artificially generating a first mechanical defect of a first magnitude in or on a first group of the barrels, and artificially generating a second mechanical defect of a second magnitude in or on a second group of barrels. Thereafter, a burst pressure resistance of a subset of the first group of barrels and a burst pressure resistance of a subset of the second group of barrels is measured in respective burst pressure resistance tests.

Concurrently or thereafter, a mechanical impact of predefined magnitude is applied onto stoppers disposed inside the barrels of a further subset of the first group of barrels. A respective mechanical impact is also applied onto stoppers of a further subset of the second group of barrels.

Applying of the mechanical impact onto the stoppers of the further subsets of the first and second groups of barrels or even of further groups of barrels is typically conducted in the course of a well-defined impact testing and by making use of an impact testing device. This allows to derive a quantitative and highly reproducible relation between a degree or magnitude of mechanical defect of barrels and a resulting breakage rate of such barrels. Accordingly, a breakage rate of the barrels of the further subset of the first group of barrels and of the further subset of the second group of barrels being damaged by the application of the mechanical impact is determined. Based on the determination of the breakage rate of barrels of further subsets of at least a first and a second group of barrels and based on the measured burst pressure resistance of the subsets of the at least first and second groups of barrels, the burst pressure resistance of the subsets of the first and second groups of barrels can be or is correlated with the breakage rate of the further subsets of the first and second groups of barrels.

In this way, the burst pressure resistance as to be determined by a burst pressure resistance test of such medicament containers can be directly correlated and mapped with a breakage rate of the barrels when the barrels or medicament containers are used in a well-defined impact testing arrangement, which may mimic use of the medicament container in a medical device, such as an injection device or autoinjector.

With a further example, the burst pressure resistance of the subsets of the first and second groups of barrels is correlated with the breakage rate of the further subsets of the first and second groups of barrels via the magnitude of the artificially generated first and second mechanical defects of the first and second groups of barrels.

Artificially generating different mechanical defects in distinguishable groups of the barrels allows to mutually map or to assign two different ways to characterize the mechanical integrity or mechanical stability of such barrels of medicament containers. By way of the artificially generated mechanical defects, a burst pressure resistance of medicament containers can be directly mapped and assigned to a breakage rate when such barrels are subject to a well-defined mechanical impact. Vice versa, a breakage rate of barrels as obtained by conducting a well-defined mechanical impact testing can be directly mapped and assigned to a burst pressure resistance of such medicament containers.

According to a further aspect, the disclosure relates to an impact testing device for applying an impact of predefined magnitude onto a stopper of a medicament container as described above. The impact testing device comprises a mount for supporting or receiving the medicament container. The medicament container typically comprises a vitreous barrel. The barrel may be of tubular shape. The barrel may comprise a distally located outlet. The barrel comprises a proximal end. The proximal end of the barrel is typically sealed by a piston or stopper movably disposed along the elongation of the tubular shaped barrel. The impact testing device further comprises a plunger rod displaceable relative to the mount along a longitudinal direction and configured to exert an impact of predefined magnitude onto the stopper of the medicament container when the medicament container is engaged with the mount, e.g. when the medicament container is supported by the mount or when the medicament container is attached to the mount.

The impact testing device further comprises a force and/or an impact sensor connected to the mount and operable to measure an impact or a force effect applicable by the plunger rod onto the stopper and/or to measure an impact or force effect caused by the plunger rod hitting the stopper of the medicament container, which impact or force effect is guided through or is transferred via the vitreous barrel and the liquid content. The force and/or impact sensor allows to control an impact testing. Here, only such experimental data will be used and processed, e.g. for statistical analysis, where an impact or force effect within a given size and within predefined tolerance margin is applied onto the stopper of the medicament container. Here, the force and/or impact sensor of the impact testing device provides a control that the medicament container is exposed to well-defined or predefined testing conditions.

According to a further example, the impact testing device comprises a trigger mechanism operably engaged with the plunger rod. The trigger mechanism comprises a mechanical energy storage or a reservoir of mechanical energy, which when released is operable to move the plunger rod towards the stopper of the medicament container. The mechanical energy storage in combination with a trigger allows to reproducibly generate a mechanical impact numerous times. In this way, a number of medicament containers or vitreous barrel being subject to the mechanical impact testing in a sequential order will become subject to a substantially identical force effect or mechanical impact.

According to a further example the trigger mechanism is operable to lock the plunger rod in an initial or cocked position in which the plunger rod is in a predefined distance to the stopper. Of course, and when released the plunger rod is subject to an acceleration. Depending on the distance to the stopper in an initial or cocked position the velocity of the plunger rod when hitting the stopper may vary. Such a varying velocity would have a direct influence on the mechanical impact imposed onto the stopper. With some examples, the impact testing device provides an adjustment or fine tuning of the distance between a distal end of the plunger rod and a proximal end of the stopper when the medicament container is engaged with the mount of the impact testing device.

Generally, the scope of the present disclosure is defined by the content of the claims. The injection device is not limited to specific embodiments or examples but comprises any combination of elements of different embodiments or examples. Insofar, the present disclosure covers any combination of claims and any technically feasible combination of the features disclosed in connection with different examples or embodiments.

In the present context the term ‘distal’ or ‘distal end’ relates to an end of the injection device or medicament container that faces towards an injection site of a person or of an animal. The term ‘proximal’ or ‘proximal end’ relates to an opposite end of the injection device or medicament container, which is furthest away from an injection site of a person or of an animal.

The terms “drug” or “medicament” are used synonymously herein and describe a pharmaceutical formulation containing one or more active pharmaceutical ingredients or pharmaceutically acceptable salts or solvates thereof, and optionally a pharmaceutically acceptable carrier. An active pharmaceutical ingredient (“API”), in the broadest terms, is a chemical structure that has a biological effect on humans or animals. In pharmacology, a drug or medicament is used in the treatment, cure, prevention, or diagnosis of disease or used to otherwise enhance physical or mental well-being. A drug or medicament may be used for a limited duration, or on a regular basis for chronic disorders.

As described below, a drug or medicament can include at least one API, or combinations thereof, in various types of formulations, for the treatment of one or more diseases. Examples of API may include small molecules having a molecular weight of 500 Da or less; polypeptides, peptides and proteins (e.g., hormones, growth factors, antibodies, antibody fragments, and enzymes); carbohydrates and polysaccharides; and nucleic acids, double or single stranded DNA (including naked and cDNA), RNA, antisense nucleic acids such as antisense DNA and RNA, small interfering RNA (siRNA), ribozymes, genes, and oligonucleotides. Nucleic acids may be incorporated into molecular delivery systems such as vectors, plasmids, or liposomes. Mixtures of one or more drugs are also contemplated.

The drug or medicament may be contained in a primary package or “drug container” adapted for use with a drug delivery device. The drug container may be, e.g., a cartridge, syringe, reservoir, or other solid or flexible vessel configured to provide a suitable chamber for storage (e.g., short- or long-term storage) of one or more drugs. For example, in some instances, the chamber may be designed to store a drug for at least one day (e.g., 1 to at least 30 days). In some instances, the chamber may be designed to store a drug for about 1 month to about 2 years. Storage may occur at room temperature (e.g., about 20° C.), or refrigerated temperatures (e.g., from about −4° C. to about 4° C.). In some instances, the drug container may be or may include a dual-chamber cartridge configured to store two or more components of the pharmaceutical formulation to-be-administered (e.g., an API and a diluent, or two different drugs) separately, one in each chamber. In such instances, the two chambers of the dual-chamber cartridge may be configured to allow mixing between the two or more components prior to and/or during dispensing into the human or animal body. For example, the two chambers may be configured such that they are in fluid communication with each other (e.g., by way of a conduit between the two chambers) and allow mixing of the two components when desired by a user prior to dispensing. Alternatively or in addition, the two chambers may be configured to allow mixing as the components are being dispensed into the human or animal body.

The drugs or medicaments contained in the drug delivery devices as described herein can be used for the treatment and/or prophylaxis of many different types of medical disorders. Examples of disorders include, e.g., diabetes mellitus or complications associated with diabetes mellitus such as diabetic retinopathy, thromboembolism disorders such as deep vein or pulmonary thromboembolism. Further examples of disorders are acute coronary syndrome (ACS), angina, myocardial infarction, cancer, macular degeneration, inflammation, hay fever, atherosclerosis and/or rheumatoid arthritis. Examples of APIs and drugs are those as described in handbooks such as Rote Liste 2014, for example, without limitation, main groups 12 (anti-diabetic drugs) or 86 (oncology drugs), and Merck Index, 15th edition.

Examples of APIs for the treatment and/or prophylaxis of type 1 or type 2 diabetes mellitus or complications associated with type 1 or type 2 diabetes mellitus include an insulin, e.g., human insulin, or a human insulin analogue or derivative, a glucagon-like peptide (GLP-1), GLP-1 analogues or GLP-1 receptor agonists, or an analogue or derivative thereof, a dipeptidyl peptidase-4 (DPP4) inhibitor, or a pharmaceutically acceptable salt or solvate thereof, or any mixture thereof. As used herein, the terms “analogue” and “derivative” refers to a polypeptide which has a molecular structure which formally can be derived from the structure of a naturally occurring peptide, for example that of human insulin, by deleting and/or exchanging at least one amino acid residue occurring in the naturally occurring peptide and/or by adding at least one amino acid residue. The added and/or exchanged amino acid residue can either be codable amino acid residues or other naturally occurring residues or purely synthetic amino acid residues. Insulin analogues are also referred to as “insulin receptor ligands”. In particular, the term “derivative” refers to a polypeptide which has a molecular structure which formally can be derived from the structure of a naturally occurring peptide, for example that of human insulin, in which one or more organic substituent (e.g. a fatty acid) is bound to one or more of the amino acids. Optionally, one or more amino acids occurring in the naturally occurring peptide may have been deleted and/or replaced by other amino acids, including non-codeable amino acids, or amino acids, including non-codeable, have been added to the naturally occurring peptide. Examples of insulin analogues are Gly(A21), Arg(B31), Arg(B32) human insulin (insulin glargine); Lys(B3), Glu(B29) human insulin (insulin glulisine); Lys(B28), Pro(B29) human insulin (insulin lispro); Asp(B28) human insulin (insulin aspart); human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin.

Examples of insulin derivatives are, for example, B29-N-myristoyl-des(B30) human insulin, Lys(B29) (N-tetradecanoyl)-des(B30) human insulin (insulin detemir, Levemir®); B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N—(N-palmitoyl-gamma-glutamyl)-des(B30) human insulin, B29-N-omega-carboxypentadecanoyl-gamma-L-glutamyl-des(B30) human insulin (insulin degludec, Tresiba®); B29-N—(N-lithocholyl-gamma-glutamyl)-des(B30) human insulin; B29-N-(ω-carboxyheptadecanoyl)-des(B30) human insulin and B29-N-(ω-carboxyheptadecanoyl) human insulin.

Examples of GLP-1, GLP-1 analogues and GLP-1 receptor agonists are, for example, Lixisenatide (Lyxumia®), Exenatide (Exendin-4, Byetta®, Bydureon®, a 39 amino acid peptide which is produced by the salivary glands of the Gila monster), Liraglutide (Victoza®), Semaglutide, Taspoglutide, Albiglutide (Syncria®), Dulaglutide (Trulicity®), rExendin-4, CJC-1134-PC, PB-1023, TTP-054, Langlenatide/HM-11260C (Efpeglenatide), HM-15211, CM-3, GLP-1 Eligen, ORMD-0901, NN-9423, NN-9709, NN-9924, NN-9926, NN-9927, Nodexen, Viador-GLP-1, CVX-096, ZYOG-1, ZYD-1, GSK-2374697, DA-3091, MAR-701, MAR709, ZP-2929, ZP-3022, ZP-DI-70, TT-401 (Pegapamodtide), BHM-034. MOD-6030, CAM-2036, DA-15864, ARI-2651, ARI-2255, Tirzepatide (LY3298176), Bamadutide (SAR425899), Exenatide-XTEN and Glucagon-Xten.

An example of an oligonucleotide is, for example: mipomersen sodium (Kynamro®), a cholesterol-reducing antisense therapeutic for the treatment of familial hypercholesterolemia or RG012 for the treatment of Alport syndrom.

Examples of DPP4 inhibitors are Linagliptin, Vildagliptin, Sitagliptin, Denagliptin, Saxagliptin, Berberine.

Examples of hormones include hypophysis hormones or hypothalamus hormones or regulatory active peptides and their antagonists, such as Gonadotropine (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, and Goserelin.

Examples of polysaccharides include a glucosaminoglycane, a hyaluronic acid, a heparin, a low molecular weight heparin or an ultra-low molecular weight heparin or a derivative thereof, or a sulphated polysaccharide, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium. An example of a hyaluronic acid derivative is Hylan G-F 20 (Synvisc®), a sodium hyaluronate.

The term “antibody”, as used herein, refers to an immunoglobulin molecule or an antigen-binding portion thereof. Examples of antigen-binding portions of immunoglobulin molecules include F(ab) and F(ab′)2 fragments, which retain the ability to bind antigen. The antibody can be polyclonal, monoclonal, recombinant, chimeric, de-immunized or humanized, fully human, non-human, (e.g., murine), or single chain antibody. In some embodiments, the antibody has effector function and can fix complement. In some embodiments, the antibody has reduced or no ability to bind an Fc receptor. For example, the antibody can be an isotype or subtype, an antibody fragment or mutant, which does not support binding to an Fc receptor, e.g., it has a mutagenized or deleted Fc receptor binding region. The term antibody also includes an antigen-binding molecule based on tetravalent bispecific tandem immunoglobulins (TBTI) and/or a dual variable region antibody-like binding protein having cross-over binding region orientation (CODV).

The terms “fragment” or “antibody fragment” refer to a polypeptide derived from an antibody polypeptide molecule (e.g., an antibody heavy and/or light chain polypeptide) that does not comprise a full-length antibody polypeptide, but that still comprises at least a portion of a full-length antibody polypeptide that is capable of binding to an antigen. Antibody fragments can comprise a cleaved portion of a full length antibody polypeptide, although the term is not limited to such cleaved fragments. Antibody fragments that are useful in the present disclosure include, for example, Fab fragments, F(ab′)2 fragments, scFv (single-chain Fv) fragments, linear antibodies, monospecific or multispecific antibody fragments such as bispecific, trispecific, tetraspecific and multispecific antibodies (e.g., diabodies, triabodies, tetrabodies), monovalent or multivalent antibody fragments such as bivalent, trivalent, tetravalent and multivalent antibodies, minibodies, chelating recombinant antibodies, tribodies or bibodies, intrabodies, nanobodies, small modular immunopharmaceuticals (SMIP), binding-domain immunoglobulin fusion proteins, camelized antibodies, and VHH containing antibodies. Additional examples of antigen-binding antibody fragments are known in the art.

The terms “Complementarity-determining region” or “CDR” refer to short polypeptide sequences within the variable region of both heavy and light chain polypeptides that are primarily responsible for mediating specific antigen recognition. The term “framework region” refers to amino acid sequences within the variable region of both heavy and light chain polypeptides that are not CDR sequences, and are primarily responsible for maintaining correct positioning of the CDR sequences to permit antigen binding. Although the framework regions themselves typically do not directly participate in antigen binding, as is known in the art, certain residues within the framework regions of certain antibodies can directly participate in antigen binding or can affect the ability of one or more amino acids in CDRs to interact with antigen. Examples of antibodies are anti PCSK-9 mAb (e.g., Alirocumab), anti IL-6 mAb (e.g., Sarilumab), and anti IL-4 mAb (e.g., Dupilumab).

Pharmaceutically acceptable salts of any API described herein are also contemplated for use in a drug or medicament in a drug delivery device. Pharmaceutically acceptable salts are for example acid addition salts and basic salts.

Those of skill in the art will understand that modifications (additions and/or removals) of various components of the APIs, formulations, apparatuses, methods, systems and embodiments described herein may be made without departing from the full scope and spirit of the present disclosure, which encompass such modifications and any and all equivalents thereof.

It will be further apparent to those skilled in the art that various modifications and variations can be made to the present disclosure without departing from the scope of the disclosure. Further, it is to be noted, that any reference numerals used in the appended claims are not to be construed as limiting the scope of the disclosure.

### BRIEF DESCRIPTION OF THE FIGURES

Numerous examples of medicament containers for use with the method of determining or estimating a burst pressure resistance and processing of experimental data in combination with an impact testing device will be described in greater detail by making reference to the drawings, in which:

FIG. 1 schematically shows an example of a medicament container,

FIG. 2 shows another example of a medicament container, implemented as a prefilled syringe,

FIG. 3 is indicative of an impact testing of a medicament container,

FIG. 4a shows a setup for conducting a burst pressure resistance measurement,

FIG. 4b shows another setup for conducting a burst pressure resistance measurement,

FIG. 5 is indicative of artificially generating a mechanical defect in or on a barrel,

FIG. 6 is indicative of a barrel of a first group of barrels comprising a first mechanical defect,

FIG. 7 is indicative of a barrel of a second group of barrels comprising a second mechanical defect of a second magnitude,

FIG. 8 is indicative of a barrel of a third group of barrels comprising an artificially generated third mechanical defect,

FIG. 9 shows a diagram of experimental data representing a burst pressure resistance for numerous barrels of numerous groups of barrels,

FIG. 10 is another representation of the experimental data of FIG. 9,

FIG. 11 is another diagram of experimental data indicating a breakage rate of numerous barrels of numerous groups of barrels after conducting mechanical impact testing,

FIG. 12 is indicative of a mutual correlation between a burst pressure resistance of medicament containers and a breakage rate of barrels,

FIG. 13 is a schematic illustration of one example of an impact testing device for conducting an impact test,

FIG. 14 schematically shows a portion of the impact testing device, in an initial configuration,

FIG. 15 shows a further configuration of the impact testing device after the plunger rod has been released,

FIG. 16 shows a flowchart of a method of correlating a burst pressure resistance with a breakage rate of vitreous barrel and

FIG. 17 shows a method of determining or estimating a burst pressure resistance on the basis of conducting a series of impact tests of medicament containers or barrels.

### DETAILED DESCRIPTION

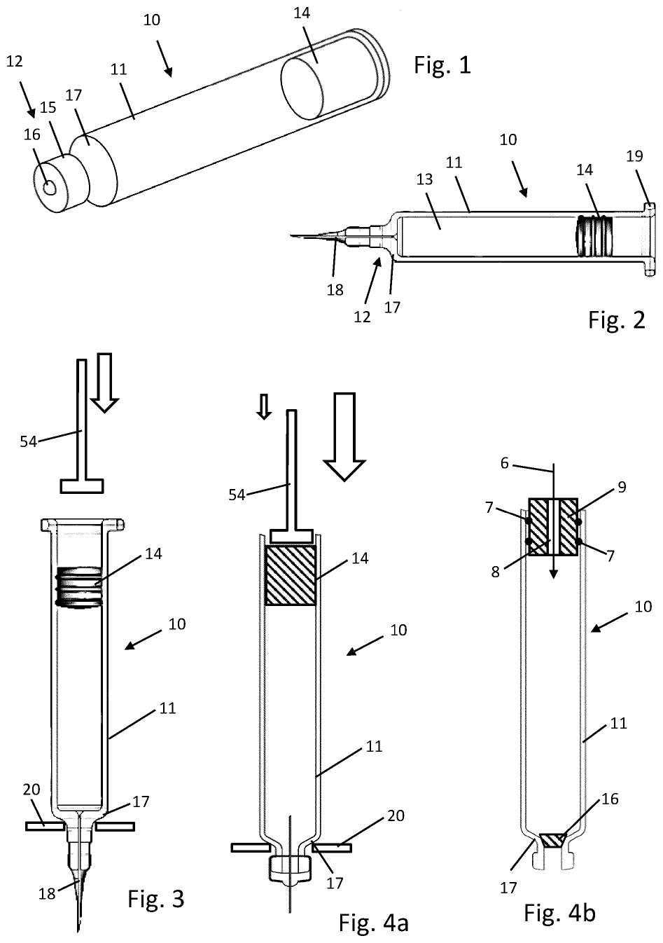

In FIG. 1, an example of a medicament container 10 is illustrated. The medicament container 10 comprises a vitreous barrel 11 of tubular shape. The barrel 11 comprises an outlet 12 near a distal end. The medicament container 10 further comprises a piston or stopper 14 sealing the interior of the barrel 11 towards an opposite longitudinal end, hence towards the proximal end.

The distal end of the medicament container 10 is also be sealed by a pierceable seal 16, which is mounted on the outlet 12 by way of a beaded cap 15. The beaded cap 15 may comprise a crimped cap made of metal, e.g. aluminum, for fixing the pierceable seal 16 onto the outlet 12.

The outlet 12 is located at a radially narrowed head or neck portion of the barrel 11. Here, the tubular barrel 11 merges into the outlet 12 via a radially narrowing shoulder portion 17. The medicament container 10 as illustrated in FIG. 1 may be implemented as a cartridge for use in an injection device, such as a handheld injection pen.

In FIG. 2 another example of a medicament container 10 is illustrated. Also here, the medicament container 10 comprises a tubular-shaped barrel 11 featuring an outlet 12 through which a portion, e.g. a dose of a liquid medicament 13 located inside the barrel 11 can be dispensed or expelled. The medicament container 10 also comprises a piston or stopper 14 sealing the proximal end of the barrel 11. The stopper 14 is displaceable relative to the sidewall of the barrel 11. It is hence slidably mounted inside the barrel 11. It may engage with an inside surface of the barrel 11 in a sealed manner. The medicament container 10 of FIG. 2 is implemented as a prefilled syringe. Here, the liquid medicament 13 is located or accommodated inside the interior confined by the barrel 11 and the stopper 14. The proximal end of the barrel 11 may be provided with a radially outwardly extending flange 19. The distal end of the barrel 11, hence the outlet 12 of the medicament container according to FIG. 2 is provided with an injection needle 18. The injection needle 18 is hollow and provides and enables dispensing of the liquid medicament from the interior of the barrel 11 into biological tissue, when the distal end of the injection needle penetrates or punctures a respective tissue section.

Generally, the medicament containers 10 as illustrated in any of the FIG. 1 or 2 may be used with injection devices, handheld injection devices and in particular with autoinjectors.

In FIG. 3, a scenario of use of such a medicament container 10 in an autoinjector or injection pen is schematically illustrated. There, the medicament container 10 may be engaged in longitudinal direction with an abutment 20. As illustrated, t a radially widening shoulder portion 17 of the medicament container 10 is in longitudinal abutment with the abutment 20. In typical implementations, the abutment 20 is provided by the housing of the injection device or by some support component connected to the housing of the injection device. By way of the support 55, the medicament container 10 is supported in longitudinal distal direction. Alternatively, but not illustrated also the distal end of the medicament container 10 may be engaged with or axially supported by the abutment 20 when assembled inside an injection device.

In a typical scenario of use with an autoinjector, a plunger rod 54 is accelerated in distal direction and hits the proximally facing surface of the stopper 14. Accordingly, the stopper 14 and the barrel 11 will be subject to a well-defined mechanical impact.

In FIG. 4a, a different situation is illustrated. Here, a plunger rod 54 is in longitudinal abutment with the stopper 14. Then, a gradually increasing distally directed pressure is applied onto the stopper 14 through the plunger rod 54. When the pressure applied by the plunger rod 54 equals or exceeds the burst pressure resistance of the medicament container 10, the barrel 11 of the container 10 will start to crack and to disintegrate and/or to break in fragments. At least with the example of FIG. 4a, the injection needle 18 as illustrated to penetrate the seal 16 at the outlet 12 of the medicament container 10 may be clogged or sealed or may even not be present. With the example of FIG. 4a, and when gradually increasing the pressure onto the stopper 14, for the purpose of burst pressure testing, a liquid substance contained inside the barrel 11 may be hindered to escape from the interior volume of the medicament container 10. Either the injection needle 18 may not be present or, in case the injection needle 18 should be embedded or fixed in the distal end or outlet 12 of the medicament container 10 it may be clogged or otherwise sealed.

With the example of FIG. 4b, a further testing scenario for measuring of a burst pressure resistance of a barrel 11 of a medicament container 10 is schematically illustrated. Here, the barrel 11 is sealed in distal direction by a seal 16, which is sized and shaped to effectively clog the distal outlet of the barrel 11. The proximal end of the barrel 11 is sealed by a nozzle 9. Here, the nozzle 9, e.g. comprising a stopper or stopper body with a hollow through opening 8 or through bore, is in sealing engagement with the sidewall of the barrel 11. The sealing engagement between the nozzle 9 and the barrel 11 may be obtained via one or several sealing rings 7, e.g. implemented as O-rings, enclosing an outer circumference of the nozzle 9 and being in sealing engagement with the inside of the barrel 11. Typically, the through opening 8 of the nozzle 9 is in flow communication with a source of a pressurized liquid medium 6.

The nozzle 9 with its axial through opening 8 serves to guide the liquid substance 6 into the interior of the barrel 11. Typically, the nozzle 9 and/or its through opening 8 is impinged with the pressurized liquid substance 6, e.g. water, to gradually increase a hydraulic pressure inside the barrel 11. The pressure level applied to the liquid substance 6 inside the barrel 11 is monitored so as to determine the burst pressure resistance of the barrel 11, i.e. the pressure level of the liquid substance 6, at which the barrel 11 is damaged and starts to crack due to excessive pressure.

The examples of FIGS. 3 and 4a, b show different embodiments of how the medicament container 10 can be longitudinally supported inside a housing of an injection device. With the illustration of FIG. 3, the distal end and hence a distal end face of the head section of the outlet 12 of the medicament container 10 is in direct abutment with the abutment 20, which may merely serve as a mechanical support. With the example of FIGS. 4a and 4b, the abutments 20 is in longitudinal abutment with the shoulder portion 17 of the barrel 11 of the barrel 11.

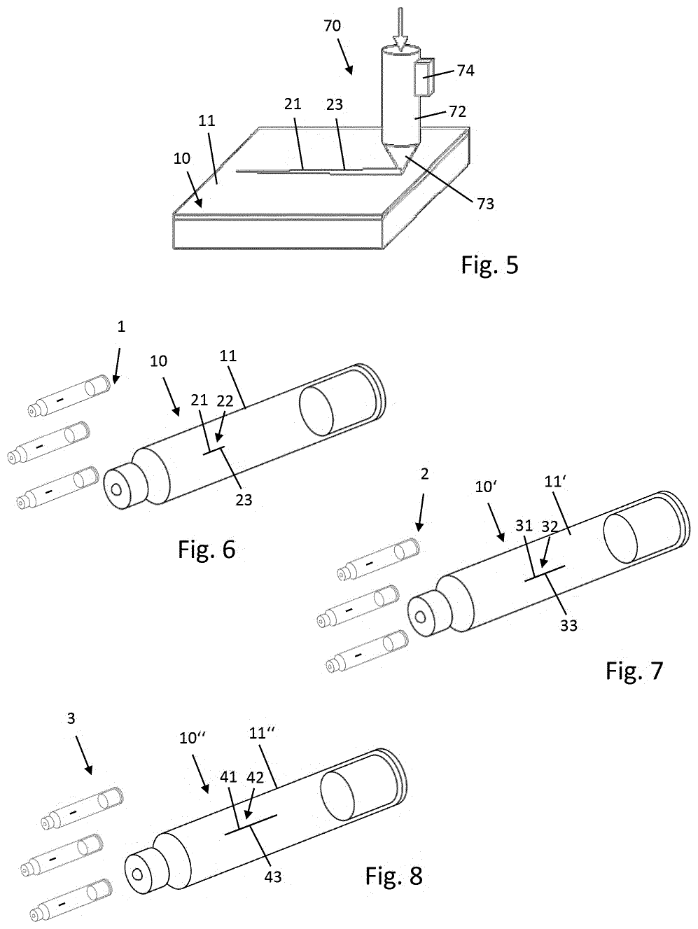

In FIG. 5, artificial generation of a mechanical defect 21 onto an outside surface 71 of a barrel 11 of a medicament container 10 is schematically illustrated. Here, only a portion of a sidewall of the barrel 11 is shown. A dedicated tool 70 is used to produce a mechanical damage or defect 21 into the outside surface 71 of the barrel 11. The tool 70 as illustrated may comprise a mandrel 72 or spike with a pointed tip 73 that is urged with a well-defined force onto the outside surface 71 of the barrel 11. The tool 70 may comprise a mount (not illustrated) and a force sensor 74 by way of which an indentation force or a pressure applied by the tool 70 onto the outside surface 71 can be measured. In this way, mechanical defects 21 of well-defined magnitude can be reproducibly applied to a large number of barrels 11 of medicament containers 10.

In the sequence of FIGS. 6, 7 and 8 different examples of a medicament containers 10, 10′, 10″ are illustrated each of which belonging to a different group1, 2, 3 of the barrels 11, 11′, 11″ that distinguish by the magnitude of their respective mechanical defects 21, 31, 41. FIG. 6 shows a first group 1 of barrels 11, wherein one of the medicament containers 10 and its respective barrel 11 is illustrated in greater detail just for illustration purpose. This medicament container and the barrel 11 comprises a first mechanical defects 21 of a first magnitude 22. Here, the first mechanical defect 21 comprises an elongated scratch 23, e.g. produced by a tool 70 as illustrated in FIG. 5.

The medicament container 10′ and the barrel 11′ as illustrated in FIG. 7 is taken from a second group of barrels 2 and from the same batch of barrels from which also the barrels 11 and 11″ of FIGS. 6 and 8 have been selected or taken. The medicament container 10′ and its barrel 11′ represent a second group 2 of barrels 11′ that distinguish from the first group 1 of barrels 11 by the magnitude 32 of the mechanical defect 31. Here, the respective scratch 33 is of larger magnitude compared to the scratch 23 of barrel 11 of FIG. 6. The scratch 33 and the scratch 23 at least distinguish by their elongation.

In still another example as illustrated in FIG. 8, there is shown one sample of a third group 3 of medicament containers 10″ comprising a respective third group of barrels 11″. This barrel 11″ comprises a third mechanical defect 41 with a third magnitude 42. As illustrated, the elongation or size of the respective scratch 43 is larger than the scratch 33 of the barrel 11′ and is also larger or longer than the scratch 23 of the barrel 11 of FIG. 6.

The illustration of three medicament containers 10, 10′, 10″ and of respective barrels 11, 11′, 11″ is only exemplary for at least three discrete groups1, 2, 3 of barrels 11, 11′, 11″ each comprising a comparatively large number of barrels or medicament containers. The barrels of each group of barrels each comprise a substantially identical mechanical defect 21. The second group of barrels or medicament containers comprises a second mechanical defect 31 that is of a different magnitude 32 compared to the magnitude 22 of the group of barrels 11. Also here, each barrel 11′ of the second group of barrels 11′ comprises a mechanical defect 31 with a second magnitude 32, wherein all barrels 11′ belonging to the same group are substantially identical with regard to the magnitude of their respective artificially generated mechanical defect.

The same applies to the medicament containers 10″ and barrels 11″ of the third group as illustrated in FIG. 8. In FIGS. 6, 7 and 8 only one exemplary medicament container 10, 10′, 10″ of a comparatively large number, e.g. 10, 20, 50, 100 or even more medicament containers, all provided with a substantially identical mechanical defect is apparently illustrated.

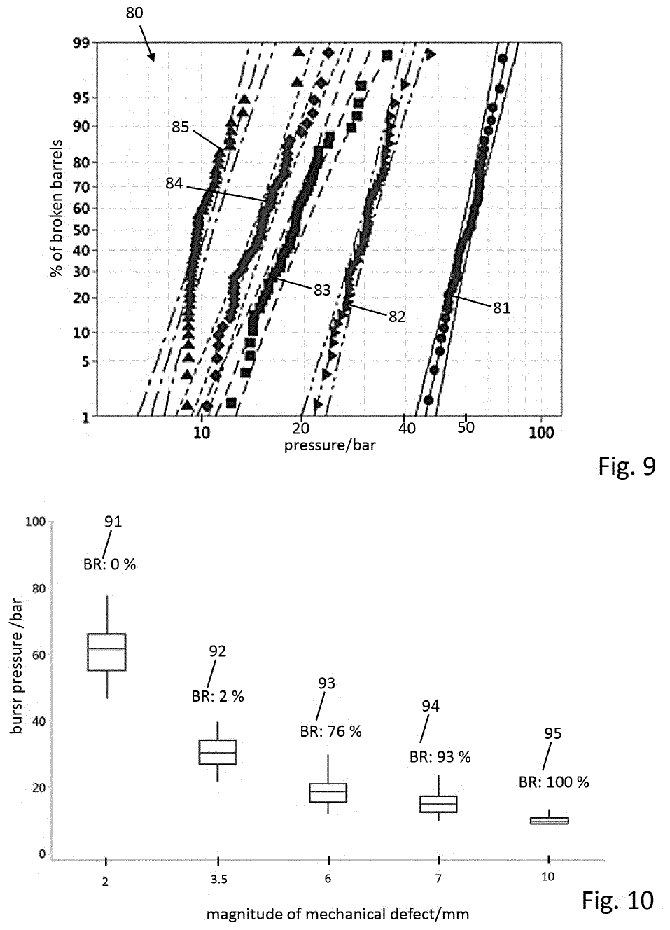

In FIGS. 9-12 experimental data obtained from impact testing and burst pressure resistance testing of five different groups of barrels 11 for medicament containers 10 is illustrated. There have been prepared five different groups of barrels 11, each of which being provided with an artificially generated mechanical defect. Here, a longitudinal scratch of variable length has been introduced into the barrels thereby defining the different groups.

With the presently illustrated examples, the barrels 11 of a first group are all provided with a scratch having a scratch length of 2 mm. The barrels 11 of a second group are provided with a scratch of a scratch length of 3.5 mm. The barrels 11 of a third group are provided with a scratch featuring a scratch length of 6 mm. The barrels of a fourth group are provided with a scratch of a scratch length of 7 mm and the barrels 11 of a fifth group are provided with a scratch featuring a scratch length of 10 mm.

Just as an example each group of barrels contains about 100 identically prepared barrels. A subset of the barrels of each group will then become subject to a burst pressure resistance testing and another subset of the same group of barrels will be subject to an impact testing. For instance, 50% of the barrels of each group will be subject to the burst pressure resistance testing and the other 50% of the same group of barrels will be subject to the mechanical impact testing. The burst pressure resistance testing and the impact testing is applied to all five groups of barrels 11.

In FIG. 9, the result of a pressure resistance test conducted for 50% of the barrels of each group of barrels is schematically illustrated in a logarithmic representation. In vertical direction there is illustrated the percentage of broken barrels over a burst pressure applied to the barrels. The diagram 80 comprises five graphs 81, 82, 83, 84, 85. Here, the graph 81 corresponds to the first group of barrels. The graph 82 represents the burst pressure resistance of the second group of barrels. The graph 83 represents the burst pressure resistance of the third group of the barrels. The graph 84 represents the burst pressure resistance of the fourth group of barrels and the graph 85 represents the burst pressure resistance of the fifth group of barrels 11.

As one can tell from the logarithmic representation of the pressure applied to the stopper 14 of the respective medicament containers 10 the percentage of barrels broken at a particular pressure substantially follows a straight line. As one can tell from the graph 81 of FIG. 9 for the barrels 11 of the first group all barrels were able to withstand a pressure of about 40 bar. Some of the barrels of the first group 11 start to crack or to disintegrate at a pressure of about 45 bar. At a pressure of about 50 bar less than 5% of the barrels were damaged. It is only at a pressure level of about 80 bar that almost 100% of the barrels 11 of the first group were damaged.

As one can easily derive from the graphical representation of FIG. 9 the larger the artificially generated mechanical defect will be, the sooner the medicament containers 10 and their respective barrels 11 will become subject to breakage when the pressure applied during a burst pressure resistance testing is increased. For instance, with the fourth group as represented by graph 84 about 95% of the barrels will break when a pressure of about 20 bar is applied. With the fifth group of barrels as represented by graph 85 there will be 95% of broken barrels at a pressure of about 15 bars.

In FIG. 10 another graphical representation of the statistical data as illustrated in FIG. 9 is presented. There, for each group of barrels a box plot representation is provided. Here, the burst pressure is represented for each family over the magnitude of mechanical defect. The vertically extending upper and lower lines in the box plot illustration represents the upper and lower limit in which 25% of the broken cartridges are located. The box in the middle between the vertical lines represent 50% of the barrels or medicament containers for which the burst pressure resistance testing has been conducted.

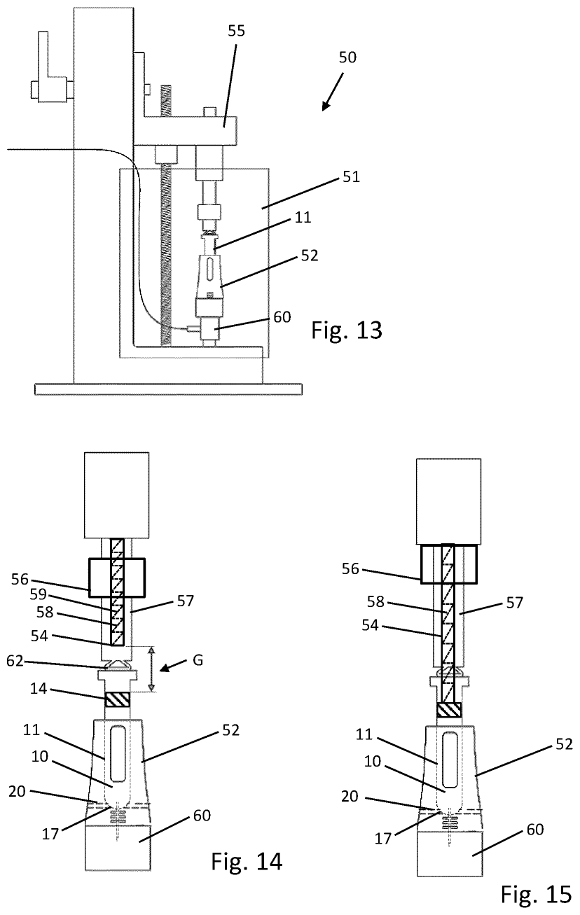

The further subset of the groups of barrels or medicament containers has been concurrently subject to an impact testing, the details of which will be described in connection with FIGS. 13-15. The impact testing is conducted with well-defined and constant impact testing parameters for all barrels and medicament containers of all groups of medicament containers and barrels. The impact testing conducted for the number of barrels of a subset of the respective group of barrels provides a breakage rate. The respective breakage rates are illustrated as BR in FIG. 10.

As illustrated therein, the breakage rate 91 of the first group of barrels 11 is 0%. The breakage rate 92 of the second group of barrels 11 is 2%. The breakage rate 93 of the third group of barrels 11 is 76%. The breakage rate of the fourth group of barrels 11 is 93% and the breakage rate of the fifth group of barrels 11 is 100%. In this way, the breakage rate can be correlated to the magnitude of the mechanical defect as represented by the grouping of the barrels 11 into groups that distinguish by the magnitude of an artificially generated mechanical defect.

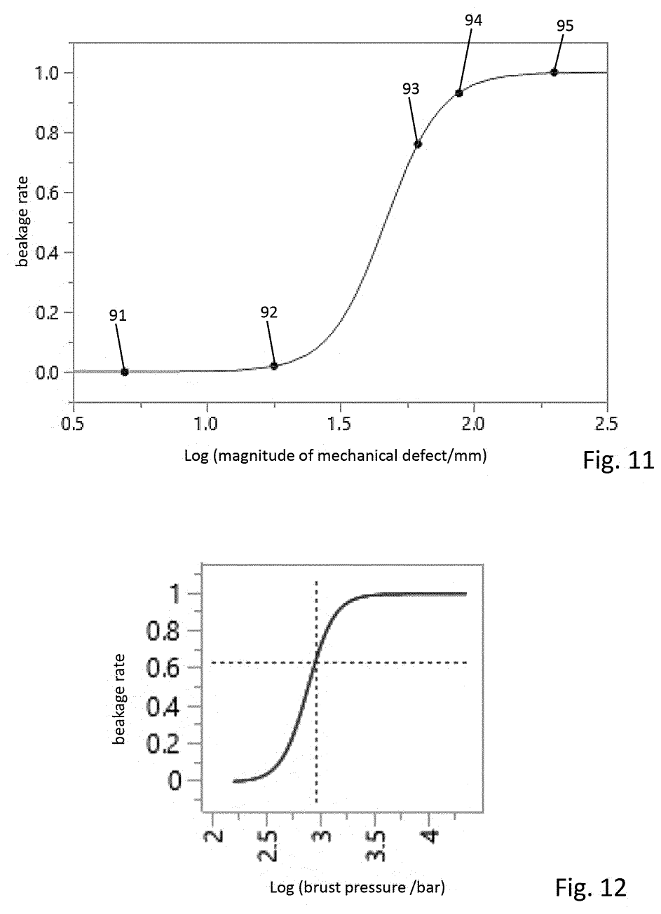

In FIG. 10 the breakage rates 91, 92, 93, 94, 95 of the numerous groups of barrels 11 are illustrated versus the magnitude of the mechanical defect. Also here, the magnitude of the mechanical defect is provided on a logarithmic scale. The breakage rate is provided by a ratio between 0.0. and 1.0 respectively. The numerous breakage rates 91, 92, 93, 94, 95 are indicated in the diagram of FIG. 11. Moreover, and in order to provide a breakage correlation between the breakage rate of the barrels 11 and the magnitude of the artificially generated mechanical defect of the barrels 11 a numerical regression is conducted on the basis of the experimentally obtained data. In this way, a smooth graph is fitted over the breakage rates 91, 92, 93, 94, 95 allowing to interpolate or extrapolate data for which no experimental values have been recorded.

Since the breakage rate is correlated by the breakage correlation as illustrated in FIG. 11 and since there is also provided a burst correlation between the burst pressure resistance and the magnitude of the artificially generated mechanical defect, the breakage rate can be directly mapped or assigned to the burst pressure resistance as illustrated in FIG. 12. This mutual mapping or assignment is conducted on the basis of the magnitude of the artificially generated mechanical defects by way of which the two different ways to categorize the mechanical integrity of the cartridge, namely burst pressure resistance and impact resistance can be mutually mapped and assigned.

Here, the mutual assignment of the burst correlation and the breakage correlation provides a direct interrelation between the burst pressure resistance of a batch of medicament containers with their breakage rate when subject in a well-defined impact testing scenario. In this way, a manufacturer of a medical device, such as an autoinjector, may set or define a lower acceptable limit of a particular percentage of medicament containers that may break when implemented or used with an auto in injector. Through the diagram as illustrated in FIG. 12 the breakage rate limit can be transferred into a burst pressure resistance limit. In this way, a batch of medicament containers exhibiting less than a maximally allowable minimum breakage rate can be reliably mapped and assigned to a batch of medicament containers featuring a minimum burst pressure resistance. Likewise, a minimum burst pressure resistance can be mapped to a maximally allowable minimal breakage rate.

A requirement of a pharmaceutical manufacturer or of a device manufacturer in terms of a maximum allowable breakage rate can be reliably and precisely mapped or assigned to a minimally required burst pressure resistance.

For instance, when a device manufacturer requires that a maximum breakage rate should be less than 0.1%, based on the available experimental data and for a particular impact testing mimicking the mechanical load of a medicament container in a medical device, this demand can be translated or extrapolated into a fictive scratch length of about 1 mm. Such a fictive extrapolated magnitude of the mechanical defect corresponds to a minimum burst pressure resistance, which, on the basis of the available experimental data would be about 19 bars. The other way round from the statistical analysis and based on the burst correlation and/or breakage correlation as described above a batch of medicament containers exhibiting an average burst pressure resistance of more than 19 bars can be predicted to exhibit a breakage rate when implemented in an autoinjector of less than 0.1%, thus matching the limit of the device manufacturer or pharmaceutical manufacturer.

It should be noted that the experimental data as illustrated herein is only exemplary and that acceptable breakage rates as described herein may not represent a real scenario of device manufacturing. Real values for acceptable or tolerable breakage rates may be much stricter.

In FIGS. 13-15 one example of an impact testing device 50 is illustrated. The impact testing device 50 comprises a mount 52 that supports or receives the medicament container 10. The impact testing device 50 further comprises a plunger rod 54 that is displaceable relative to the mount 52 along a longitudinal direction. As it becomes immediately apparent from a comparison of FIGS. 14 and 15 the plunger rod 54 is displaceable relative to the mount 52 through the action of a mechanical energy storage 58, which in the presently illustrated example is implemented as a mechanical spring 59. The medicament container 10 is supported in longitudinal direction by an abutment 20 of the mount 52.

Here, the medicament container 10 rests with its shoulder portion 17 on the abutment 20. The abutment 20 and/or the mount 52 is operably connected to a sensor 60. The sensor 60 is implemented as a force and/or impact sensor by way of which an impact and/or force exerted by the plunger rod 54 onto the medicament container 10 can be measured. The impact testing device further comprises a trigger mechanism 56. The trigger mechanism may be movably disposed on a guiding rod 57. The guiding rod 57 may be hollow and may provide a longitudinal guiding for the plunger rod. Moreover, the mechanical spring may be also located inside the hollow plunger rod 54.

The trigger mechanism 56 may be operable to bias the mechanical energy storage 58. For this, the trigger mechanism 56 may be movable in proximal direction, hence away from the medicament container 10. As soon the trigger mechanism 56 reaches a proximal end position it may be configured to automatically release the mechanical energy storage 58. In this way, the mechanical spring 59 serves to push the plunger rod 54 towards the stopper 14 of the medicament container 10. The distal end of the guiding rod 57 may be provided with a holder 62 by way of which the proximal end of the barrel 11 can be at least slightly fixed in the upright orientation of the medicament container as illustrated in FIGS. 13-15.

The plunger rod 54 and the trigger mechanism 56 are mounted on a support 55 which is adjustable with regard to the longitudinal direction. In this way, a size of a gap G between the distal end of the plunger rod 54 and the proximal end of the stopper 14 of the medicament container 10 can be adjusted. In this way, the constant gap size G between the distal end of the plunger rod 54 and the proximal end of the stopper 14 can be maintained for a sequence of medicament containers to be tested with the impact testing device 50.

A constant size of a gap G between the plunger rod 54 and the stopper 14 is quite important to apply a mechanical impact of equal magnitude to the respective subset of medicament containers 10 to be tested with the impact testing device 50. Here, and when the container 10 would be supported in distal direction by the abutment 20 in engagement with the shoulder portion 17 it should be noted, that especially the shoulder portion 17 due to manufacturing reasons may be subject to comparatively large geometric tolerances. Adjusting the size of the gap G is therefore beneficial to maintain constant conditions for sequence of impact tests.

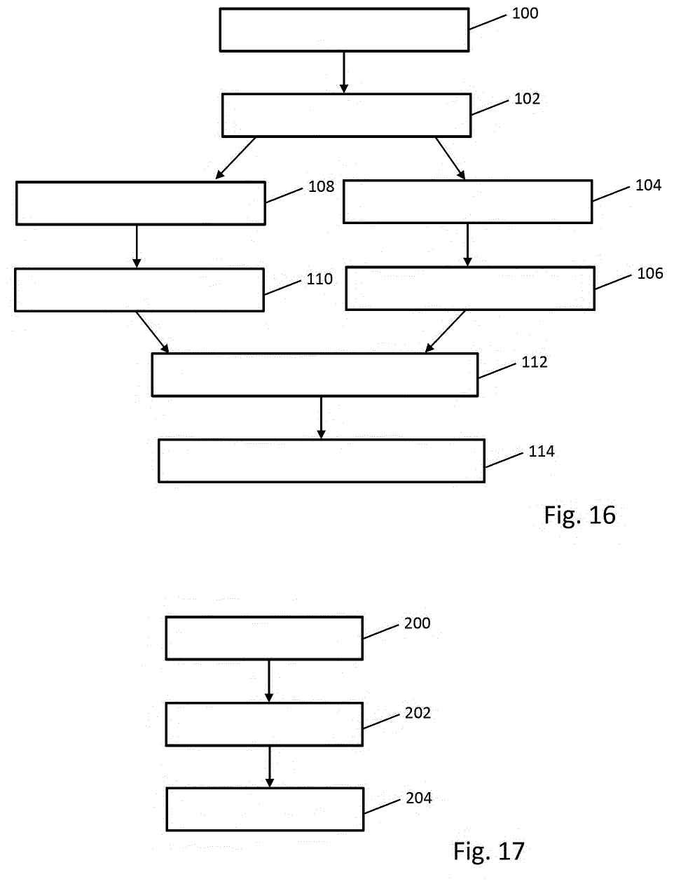

In FIG. 16 a flowchart is illustrated of how to deriving a burst correlation and a breakage correlation. In a first step 100 numerous groups of barrels from a batch of barrels are defined. Once the batch of barrels has been separated in different groups, in a subsequent step 102 each group of the barrels 11 is provided with an artificially generated mechanical defect. As described above, each group distinguishes from another group by the magnitude of its mechanical defect. In each group of barrels, the barrels have substantially a common or substantially identical mechanical defect.

A portion, i.e. a subset of each group of the barrels will then be subject to a burst pressure measurement in step 108. Concurrently, another subset of the barrels of the group of barrels will be subject to an impact testing in step 104, e.g. conducted by the impact testing device 50 as described above. The results of the burst pressure measurement and the respective data is processed in step 110. Based on the measured burst pressure resistance values of the medicament containers a burst correlation is derived. Based on the impact testing a breakage rate of each group of medicament containers is determined and based on the breakage rate a breakage correlation is derived in step 106. Based on the burst correlation as provided in step 110 and based on the breakage correlation provided in step 106 a numerical regression and/or a statistical model is derived in step 112. Based on the numerical regression or statistical model a burst pressure resistance of a batch of medicament containers may be derived in step 114 only on the basis of conducting an impact testing of a sample batch of medicament containers.

This final step 114 of the method and hence use of the method for determining or estimating a burst pressure resistance of a batch of medicament container 10 is further described in the flowchart of FIG. 17. There, in step 200 a batch of medicament containers is subject to a burst testing, typically, by employing a radially and/or monotonically increasing pressure onto the piston of the barrel and/or by gradually increasing a fluid pressure inside the barrel 11 of the medicament container. In step 202, the highest pressure value of burst testing is determined. Here, the maximum allowable pressure above which the barrel 11 is subject to damage or breakage is determined. This maximum allowable pressure represents the burst pressure resistance of the medicament container. By making use of the numerical regression or statistical model as described above the quality of the batch in terms of a predicted breakage rate under impact testing is derived in step 204. The predicted breakage rate under impact testing is derived on the basis of the maximum burst pressure resistance actually measured with a representative group of barrels of the batch of medicament containers. The batch is then evaluated to be acceptable or non-acceptable with regard to a predefined or desired maximum allowed breakage rate.

### LIST OF REFERENCE NUMBERS

1 group of barrels
2 group of barrels
3 group of barrels
6 liquid substance
7 sealing ring
8 through opening
9 nozzle
10 medicament container
11 barrel
12 outlet
13 liquid medicament
14 stopper
15 beaded cap
16 seal
17 shoulder portion
18 injection needle
19 flange portion
20 abutment
21 mechanical defect
22 magnitude
23 scratch
31 mechanical defect
32 magnitude
33 scratch
41 mechanical defect
42 magnitude
43 scratch
50 impact testing device
51 housing
52 mount
54 plunger rod
55 support
56 trigger mechanism
57 guiding rod
58 mechanical energy storage
59 mechanical spring
60 sensor
62 holder
70 tool
71 surface
72 mandrel
74 sensor
80 diagram
81 graph
82 graph
83 graph
84 graph
85 graph
91 breakage rate
92 breakage rate
93 breakage rate
94 breakage rate
95 breakage rate

1-15. (canceled)

16. A method of determining or estimating a burst pressure resistance of a batch of medicament containers, wherein each medicament container of the batch of medicament containers comprises a vitreous barrel filled with a liquid substance and is sealed by a stopper slidably disposed inside of the vitreous barrel, and wherein the method comprises:
applying a mechanical impact of a predefined magnitude onto the stopper of each medicament container of a subset of the batch of medicament containers;
determining a breakage rate of vitreous barrel of the subset of the batch of medicament containers that are mechanically damaged by the mechanical impact; and
deriving the burst pressure resistance of the batch of medicament containers based on the breakage rate of the vitreous barrels mechanically damaged by the mechanical impact.

17. The method according to claim 16, wherein deriving the burst pressure resistance of the batch of medicament containers comprises providing a correlation between the burst pressure resistance of the batch of medicament containers and the breakage rate of the vitreous barrels mechanically damaged by the mechanical impact.

18. The method according to claim 16, wherein deriving the burst pressure resistance of the batch of medicament containers comprises using a correlation between the burst pressure resistance of the batch of medicament containers and the breakage rate of the vitreous barrels mechanically damaged by the mechanical impact.

19. The method according to claim 17, wherein providing the correlation between the burst pressure resistance of the batch of medicament containers and the breakage rate of the vitreous barrels comprises:
artificially generating a first mechanical defect of a first magnitude in or on a first group of vitreous barrels of the batch of medicament containers; and
artificially generating a second mechanical defect of a second magnitude in or on a second group of vitreous barrels of the batch of medicament containers.

20. The method according to claim 19, wherein providing the correlation between the burst pressure resistance of the batch of medicament containers and the breakage rate of the vitreous barrels further comprises:
measuring a first burst pressure resistance of a first subset of the first group of vitreous barrels; and
measuring a second burst pressure resistance of a second subset of the second group of vitreous barrels.

21. The method according to claim 20, wherein providing the correlation between the burst pressure resistance of the batch of medicament containers and the breakage rate of the vitreous barrels further comprises deriving of a burst correlation between the burst pressure resistance and the first and second magnitudes of the first and second mechanical defects.

22. The method according to claim 19, wherein providing the correlation between the burst pressure resistance of the batch of medicament containers and the breakage rate of the vitreous barrels further comprises:
applying a further mechanical impact of the predefined magnitude onto the stopper of a further subset of the first group of vitreous barrels and determining a breakage rate of vitreous barrels of the further subset of the first group of vitreous barrels mechanically damaged by the further mechanical impact; and
applying the further mechanical impact of the predefined magnitude onto the stopper of a further subset of the second group of vitreous barrels and determining a breakage rate of vitreous barrels of the further subset of the second group of vitreous barrels mechanically damaged by the further mechanical impact.

23. The method according to claim 22, wherein providing the correlation between the burst pressure resistance of the batch of medicament containers and the breakage rate of the vitreous barrels further comprises deriving a breakage correlation between the breakage rate of the vitreous barrels and the first and second magnitudes of the first and second mechanical defects of the vitreous barrels.

24. The method according to claim 23, wherein deriving the breakage correlation between the breakage rate of vitreous barrels and the first and second magnitude of the first and second mechanical defects comprises applying a numerical regression analysis based on the breakage rate determined for each of the first and second subgroups of vitreous barrels mechanically damaged by the mechanical impact.

25. The method according to claim 21, wherein the correlation between the burst pressure resistance of the batch of medicament containers and the breakage rate of the vitreous barrels is derived by mutually correlating the burst correlation and a breakage correlation based on the first and second magnitudes of the first and second mechanical defects, wherein the breakage correlation is a correlation between the breakage rate of the vitreous barrels and the first and second magnitudes of the first and second mechanical defects of the vitreous barrels.

26. The method according to claim 21, wherein the correlation between the burst pressure resistance of the batch of medicament containers and the breakage rate of the vitreous barrels is derived by mutually combining the burst correlation and a breakage correlation based on the first and second magnitudes of the first and second mechanical defects, wherein the breakage correlation is a correlation between the breakage rate of the vitreous barrels and the first and second magnitudes of the first and second mechanical defects of the vitreous barrels.

27. The method according to claim 19, wherein the first and second mechanical defects in or on the first and second groups of vitreous barrels each comprise at least one scratch in the vitreous barrel.

28. The method according to claim 27, wherein the at least one scratch of the first mechanical defect distinguishes from at least one scratch of the second mechanical defect by at least one of: a scratch geometry, a scratch shape, a scratch length, a scratch width, a scratch depth, a number of individual scratches, and a spatial distribution of numerous individual scratches.

29. The method according to claim 23, wherein for a breakage rate which is measured for the first or second group of vitreous barrels, the first or second magnitude of the first or second mechanical defect is determined or estimated based on the breakage correlation.

30. The method according to claim 21, wherein for a burst pressure resistance measured for a medicament container of the batch of medicament containers, a magnitude of an artificially generated mechanical defect is determined or estimated based on the burst correlation.

31. An impact testing device for applying an impact of a predefined magnitude onto a stopper of a medicament container, the impact testing device comprising:
a mount for supporting or receiving the medicament container;
a plunger rod displaceable relative to the mount along a longitudinal direction and configured to exert the impact of the predefined magnitude onto the stopper of the medicament container when the medicament container is engaged with the mount; and
a force and/or impact sensor connected to the mount and operable to measure the impact or a force effect applicable by the plunger rod onto the stopper.

32. The impact testing device according to claim 31, further comprising a trigger mechanism operably engaged with the plunger rod.

33. The impact testing device according to claim 32, wherein the trigger mechanism comprises a mechanical energy storage that, when released, is operable to move the plunger rod towards the stopper of the medicament container.

34. The impact testing device according to claim 31, wherein the trigger mechanism is operable to lock the plunger rod in an initial or cocked position.

35. The impact testing device of claim 34, wherein in the initial or cocked position, the plunger rod is positioned at a predefined distance from the stopper.
